(19) United States
(12) Patent Application Publication
(10) Pub. No.: US 2025/0290358 A1
(43) Pub. Date: Sep. 18, 2025

(54) DOOR HANDLE DEVICE

(71) Applicants: Minebea AccessSolutions Inc., Miyazaki-shi (JP); HONDA MOTOR CO., LTD., Tokyo (JP); U-Shin Ltd., Nagano (JP)

(72) Inventors: Yuki YAMAMURA, Miyazaki (JP); Takahiro YAMADA, Miyazaki (JP); Yoichi KATAYAMA, Tokyo (JP); Yuichi HASHIZAKI, Hiroshima (JP)

(21) Appl. No.: 19/074,784

(22) Filed: Mar. 10, 2025

(30) Foreign Application Priority Data
Mar. 12, 2024 (JP) 2024-038093

(51) Int. Cl. E05B 85/10; E05B 77/06

(52) U.S. Cl. CPC E05B 85/103; E05B 77/06

(57) ABSTRACT

A door handle device includes a handle rotatable between an initial position at which a door latch device cannot be actuated to open and an emergency operation position at which the door latch device is manually actuated to open, via a normal operation position for electrically actuating the door latch device to open, and a restriction lever attached to a base. The restriction lever includes a normal restriction portion for restricting rotation of the handle at the normal restriction position, a restriction release portion for releasing rotational restriction of the handle by the normal restriction portion, and an emergency restriction portion for restricting rotation of the handle at the emergency restriction position.

### CROSS REFERENCE TO RELATED APPLICATION

This application claims benefit of priority to Japanese Patent Application 2024-038093, filed Mar. 12, 2024, the entire content of which is incorporated herein by reference.

### BACKGROUND

### Technical Field

The present invention relates to a door handle device.

### Background Art

A door latch device and a door handle device are attached to a door of a vehicle. The door latch device includes a latch mechanism and is switchable between a latched state in which the door is held in a closed state with respect to a vehicle body and an unlatched state in which the door can be opened with respect to the vehicle body. An opening actuation of the latch mechanism from the latched state to the unlatched state is accomplished by an operation of the door handle device in two methods. A first method is an electric opening actuation by an actuator provided in the door latch device. A second method is a manual opening actuation by transmitting an operating force of the door handle device.

A door handle device disclosed in JP 4914478 B includes a handle that is rotatable between an initial position and an emergency operation position via a normal operation position. In addition, the door handle device includes a restriction mechanism for restricting rotation of the handle, and a restriction release mechanism for releasing restriction of the handle. In a normal state, the restriction mechanism allows the rotation of the handle from the initial position to a normal operation position and restricts the rotation of the handle from the normal operation position to the emergency operation position. Thus, the latch mechanism is electrically actuated to open. In an emergency state in which the latch mechanism cannot be electrically actuated to open, the restriction by the restriction mechanism is released by the user operating the restriction release mechanism, and the rotation of the handle from the initial position to the emergency operation position is allowed. Thus, an operating force of the handle is transmitted to the door latch device, and the latch mechanism is manually actuated to open.

The door handle device disclosed in JP 2015-90028 A includes a handle, a transmission lever, and an inertia lever, which are rotatably attached to a base, respectively. The handle is rotatable between an initial position at which the latch mechanism cannot be actuated to open and an operation position at which the latch mechanism can be actuated to open. The transmission lever transmits, to the door latch device, an operating force of the handle from the initial position to the operation position. Thus, the latch mechanism is manually actuated to open. Upon a side collision in which an impact is applied to a door (side surface) of a vehicle, the inertia lever rotates on a rotation trajectory of the transmission lever and restricts rotation of the transmission lever. As a result, the transmission of the force from the door handle device to the door latch device is cut off to prevent the opening actuation of the latch mechanism, thereby suppressing the unintended opening of the door due to the impact.

### SUMMARY

In the door handle device described in JP 2015-90028 A, in the normal state in which the door latch device can be electrically actuated to open, the manual opening actuation of the door latch device by the operation of the handle cannot be restricted. On the other hand, if the restriction mechanism of JP 4914478 B is applied to the door handle device of JP 2015-90028 A, it is possible to restrict the operation of the handle in the normal state and to suppress the unintended opening of the door upon the side collision. However, in this case, since the restriction mechanism is required in addition to the inertia lever, resulting in a disadvantage of an excessive number of parts constituting the door handle device.

The present invention relates to a door handle device used for a door latch device capable of being electrically and manually actuated to open, and an object thereof is to restrict a handle operation for manually actuating the door latch device to open in a normal state while suppressing unintended opening of a door upon a side collision, without excessively increasing the number of parts.

The present invention provides a door handle device including a base to be attached to a door, a handle attached to a vehicle exterior side of the base and configured to be rotatable between an initial position in which a door latch device attached to the door is not to be actuated to open and an emergency operation position in which the door latch device is manually actuated to open, via a normal operation position for electrically actuating the door latch device to open, and a restriction lever attached to the base. The restriction lever is movable to a normal restriction position in which rotation of the handle is restricted, a restriction release position in which rotational restriction of the handle is released, and an emergency restriction position in which rotation of the handle is restricted when an inertial force equal to or greater than a set value is applied, and includes a normal restriction portion that restricts rotation of the handle from the normal operation position to the emergency operation position when the restriction lever is positioned at the normal restriction position, a restriction release portion for releasing rotational restriction of the handle by the normal restriction portion, and an emergency restriction portion that restricts rotation of the handle to the emergency operation position when the restriction lever is positioned at the emergency restriction position.

The restriction lever is movable between the normal restriction position and the restriction release position when the inertial force equal to or greater than the set value is not applied, and is movable to the emergency restriction position when the inertial force equal to or greater than the set value is applied. In addition, the restriction lever includes the normal restriction portion that restricts rotation of the handle when the restriction lever is at the normal restriction position and the emergency restriction portion that restricts rotation of the handle when the restriction lever is at the emergency restriction position. Thus, the rotational restriction of the handle in the normal state in which the inertial force equal to or greater than the set value is not applied and the rotational restriction of the handle upon the side collision during which the inertial force equal to or greater than the set value is applied can be performed by one restriction lever. Therefore, since it is not necessary to separately provide a restriction lever for the normal state and a restriction lever for the side collision, an excessive increase in the number of parts can be suppressed.

The present invention relates to a door handle device used for a door latch device capable of being electrically and manually actuated to open, and can restrict a handle operation for manually actuating the door latch device to open in a normal state while suppressing unintended opening of a door upon a side collision, without excessively increasing the number of parts.

### BRIEF DESCRIPTION OF DRAWINGS

FIG. 1 is a block diagram of a door handle device and a door latch device according to an embodiment of the present invention.

FIG. 2 is a perspective view of the door handle device viewed from the front side.

FIG. 3 is a cross-sectional view taken along line III-III of FIG. 2.

FIG. 4 is a perspective view of the door handle device from which a cover is removed, viewed from the rear side.

FIG. 5 is a plan view of a handle, a transmission lever, a restriction lever, and an emergency button.

FIG. 6 is an exploded perspective view of FIG. 5 as viewed from the front side.

FIG. 7 is an exploded perspective view of FIG. 5 as viewed from the rear side.

FIG. 8 is a perspective view illustrating a state in which an opening operation is performed in a normal state.

FIG. 9 is a perspective view of a configuration other than a base in FIG. 8 as viewed from the back side.

FIG. 10 is a perspective view illustrating a state in which an opening operation is performed in an emergency state.

FIG. 11 is a perspective view of a configuration other than the base in FIG. 10 as viewed from the rear side.

FIG. 12 is a perspective view illustrating a state upon a side collision as viewed from the rear side.

### DETAILED DESCRIPTION

Hereinafter, an embodiment of the present invention will be described with reference to the drawings.

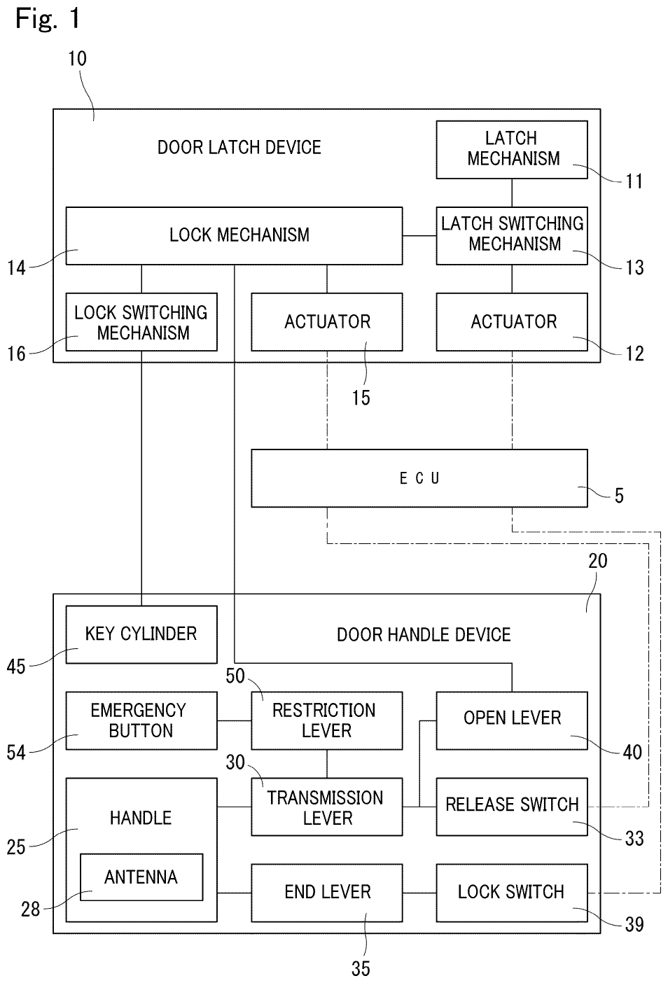

Referring to FIGS. 1 to 3, a door handle device 20 according to an embodiment of the present invention is attached to an outer panel (door panel) 2 of a door 1, and enables the door 1 in a closed state to be opened by operating a door latch device 10 attached to the same door 1. The door handle device 20 of the present embodiment is for a left side door in which a hinge shaft extends in a vehicle height direction. However, the door handle device 20 may also be used for a right side door, a slide door, or a back door.

An X direction in the accompanying drawings is a vehicle length direction, a direction indicated by an arrow is a rear side, and a direction opposite to the arrow is a front side. A Y direction is a vehicle width direction, a direction indicated by an arrow is an inner side (vehicle interior side), and a direction opposite to the arrow is an outer side (vehicle exterior side). A Z direction is a vehicle height direction, a direction indicated by an arrow is an upper side, and a direction opposite to the arrow is a lower side.

Referring to FIG. 1, the door handle device 20 is connected to an electronic control unit (ECU) 5 mounted on a vehicle. The ECU 5 includes a calculation unit, a storage unit, and a communication unit (none of which are illustrated), reads out a program stored in advance in the storage unit, and executes information processing according to steps instructed by the program. A door latch device 10 is further connected to the ECU 5. The ECU 5 electrically actuates the door latch device 10 based on an input signal from the door handle device 20.

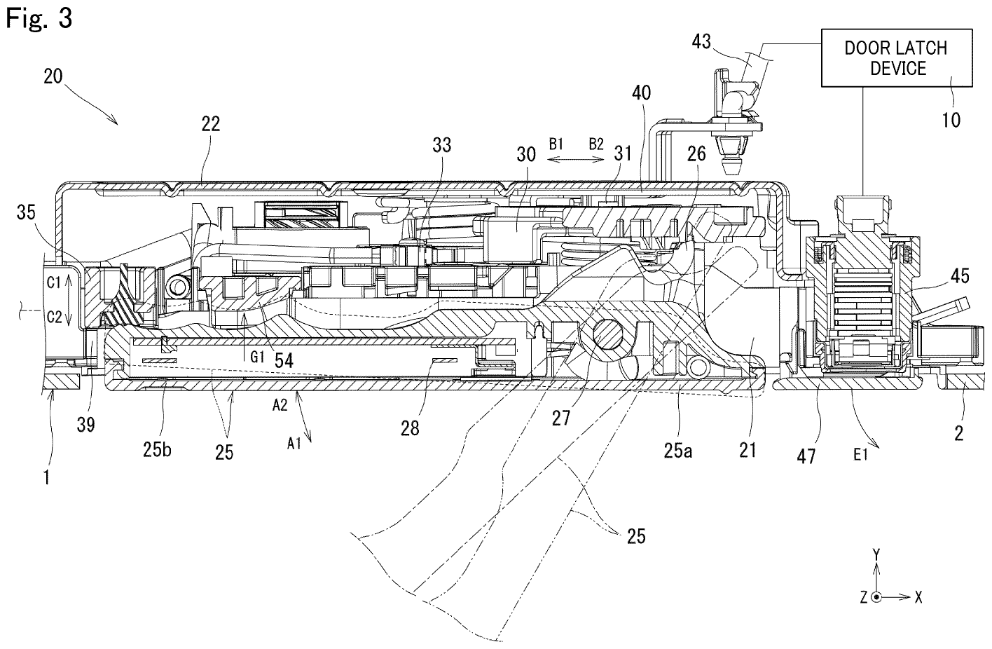

Describing the outline of the door latch device 10, the door latch device 10 is arranged along an end panel (not illustrated) of the door 1 illustrated in FIG. 3. The door latch device 10 includes a latch mechanism 11, an actuator 12, a latch switching mechanism 13, a lock mechanism 14, an actuator 15, and a lock switching mechanism 16.

The latch mechanism 11 includes a fork and a claw, and is switched between a latched state and an unlatched state. In the latched state, the fork holds a striker of the vehicle body and holds the door 1 illustrated in FIG. 3 in a closed state. In the unlatched state, the fork releases the striker, enabling the door 1 to be opened.

Switching of the latch mechanism 11 from the unlatched state to the latched state is performed by the striker entering the fork due to closing of the door 1 in the open state. Switching (opening actuation) of the latch mechanism 11 from the outside of the vehicle from the latched state to the unlatched state is performed by an operation of the door handle device 20, but is different between a normal state in which the latch mechanism 11 can be electrically actuated by the actuator 12 via the latch switching mechanism 13 and an emergency state in which the latch mechanism 11 cannot be actuated. Switching of the latch mechanism 11 by the operation of the door handle device 20 will be described in detail below.

The lock mechanism 14 is configured by a plurality of levers and the like, and is switched between an unlocked state and a locked state. In the unlocked state, the latch mechanism 11 can be switched from the latched state to the unlatched state via the latch switching mechanism 13. In the locked state, the latch mechanism 11 cannot be switched from the latched state to the unlatched state via the latch switching mechanism 13.

Switching of the lock mechanism 14 from the outside of the vehicle from the unlocked state to the locked state is performed by an operation of the door handle device 20. Switching of the lock mechanism 14 from the outside of the vehicle from the locked state to the unlocked state is performed by an operation of the door handle device 20, but is different between a normal state in which the lock mechanism 14 can be electrically actuated by the actuator 15 and an emergency state in which the lock mechanism 14 cannot be actuated. Switching of the lock mechanism 14 by the operation of the door handle device 20 will be described in detail below.

Below, the door handle device 20 according to the present embodiment will be specifically described.

The door handle device 20 includes a configuration for electrically actuating the door latch device 10 illustrated in FIG. 1 by the ECU 5 in a normal state and manually actuating the same in an emergency state. Specifically, as illustrated in FIGS. 1 to 4, the door handle device 20 includes a base 21, a cover 22, a handle 25, and a transmission lever 30. In addition, the door handle device 20 includes a release switch 33, an end lever 35, a lock switch 39, an open lever 40, a key cylinder 45, a restriction lever 50, and an emergency button 54.

The handle 25 is a flush handle elongated in the vehicle length direction and extending flush with the outer panel 2 and is rotationally operated both in a normal state and in an emergency state. The handle 25 is provided with an operation portion 26 that protrudes inward in the vehicle width direction and operates the transmission lever 30. The transmission lever 30 is arranged adjacent to a vehicle interior side of the handle 25, includes an operation receiving portion 30a that receives an operation by the operation portion 26, and rotates in conjunction with the rotation of the handle 25 both in a normal state and in an emergency state.

The release switch 33 is a detection unit for actuating the latch mechanism 11 and the lock mechanism 14 illustrated in FIG. 1 in a normal state and is arranged adjacent to the transmission lever 30. The end lever 35 and the lock switch 39 are configured to actuate the lock mechanism 14 illustrated in FIG. 1 in a normal state and are arranged on the vehicle interior side of a front end portion of the handle 25 in the vehicle length direction.

The open lever 40 is configured to rotate in conjunction with the rotation of the transmission lever 30 in an emergency state to actuate the latch mechanism 11 illustrated in FIG. 1 and is arranged below the transmission lever 30. The key cylinder 45 is configured to actuate the lock mechanism 14 illustrated in FIG. 1 in an emergency state and is arranged adjacent to the rear side of the handle 25 in the vehicle length direction.

The restriction lever 50 is configured to restrict transmission of an operating force of the handle 25 to the latch mechanism 11 illustrated in FIG. 1 via the open lever 40 by restricting rotation of the handle 25 via the transmission lever 30 in a normal state. The emergency button 54 is configured to release restriction by the restriction lever 50 in an emergency.

The control of the door latch device 10 by the ECU 5 illustrated in FIG. 1 is executed when authentication with an electronic key (not illustrated) carried by a user is established. That is, in a normal state, when the authentication with the electronic key is not established, the operation of the door latch device 10 by the ECU 5 is not executed. An antenna 28 for the ECU 5 to wirelessly communicate with the electronic key is accommodated in the handle 25.

Below, an operation including the door latch device 10 according to the operation of the door handle device 20 will be described.

### Opening Operation in Normal State

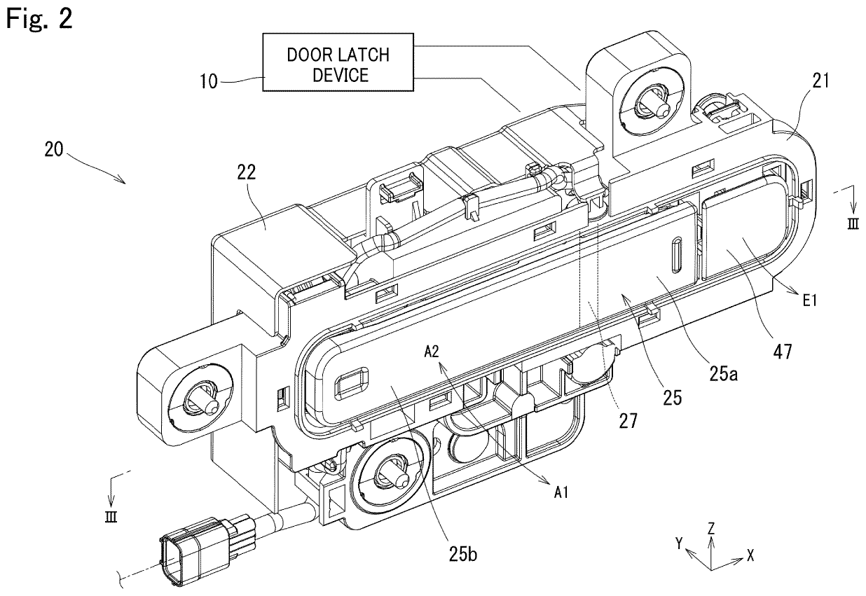

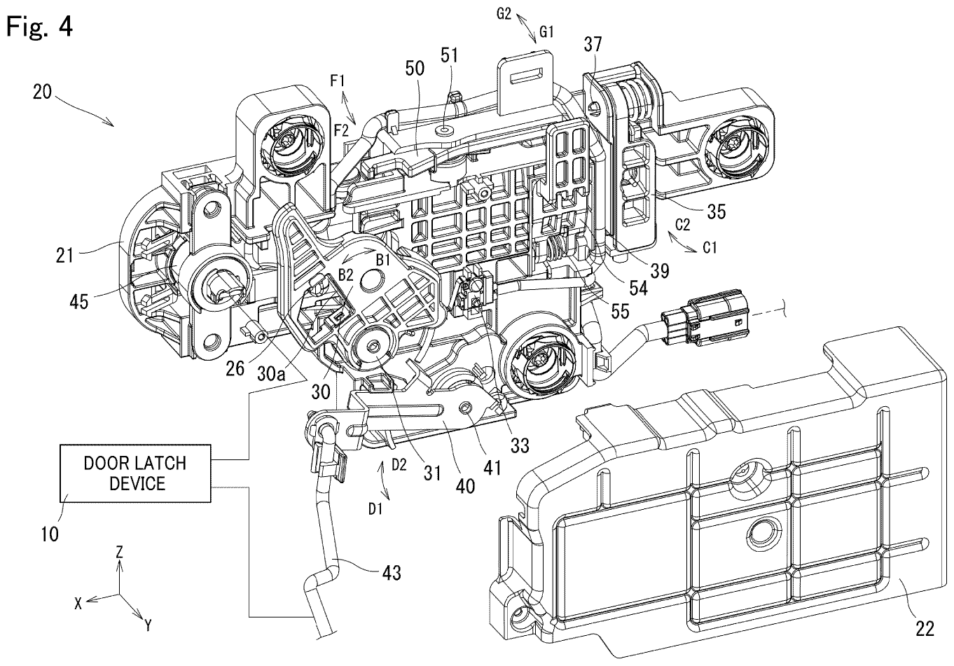

When operating the door latch device 10 to open in a normal state, a portion 25a, which is positioned on the rear side of a rotary shaft 27, of the handle 25 at the initial position indicated by a solid line in FIG. 3 is pushed inward in the vehicle width direction. As a result, the handle 25 rotates in a direction A1 in FIG. 2, and the transmission lever 30 pivotally supported by a rotary shaft 31 rotates in a direction B1 in FIG. 4. By the rotation of the transmission lever 30, the release switch 33 is switched from an off state to an on state and outputs an opening signal. As a result, the ECU 5 illustrated in FIG. 1 electrically switches the lock mechanism 14 from the locked state to the unlocked state by the actuator 15, and then electrically switches the latch mechanism 11 from the latched state to the unlatched state via the latch switching mechanism 13 by the actuator 12. Thus, the door 1 illustrated in FIG. 3 can be opened.

The rotation of the handle 25 by the operation of the rear-side portion 25a is restricted at a normal operation position indicated by the dash-dot line in FIG. 3 due to the contact of the transmission lever 30 with the restriction lever 50. In this restricted state, the release switch 33 of the transmission lever 30 can be operated as described above, but the open lever 40 cannot be operated (pressed). That is, the operating force of the handle 25 is not transmitted to the open lever 40 via the transmission lever 30 in the normal state. As a result, it is possible to prevent the electric switching and manual switching of the latch mechanism 11 from competing with each other to cause a malfunction in the door latch device 10.

### Lock Operation in Normal State

When the door latch device 10 is operated in a normal state, a portion 25b, which is positioned on the front side of the rotary shaft 27, of the handle 25 at the initial position is pushed inward in the vehicle width direction. As a result, the handle 25 rotates in a direction A2 toward a normal lock operation position indicated by the broken line in FIG. 3, and the end lever 35 pivotally supported by the rotary shaft 37 rotates in a direction C1 in FIG. 3. By the rotation of the end lever 35, the lock switch 39 is switched from an off state to an on state and outputs a lock signal. As a result, the ECU 5 illustrated in FIG. 1 electrically switches the lock mechanism 14 from the unlocked state to the locked state by the actuator 15. Thus, the door 1 illustrated in FIG. 3 cannot be opened.

### Opening Operation in Emergency State

An opening operation of the door latch device 10 in an emergency state is performed in the order of an unlocking operation of the lock mechanism 14 and an unlatching operation of the latch mechanism 11 illustrated in FIG. 1.

When unlocking the door latch device 10 in an emergency state, the cover 47 in FIG. 2 is operated in a direction E1, which is an outer side in the vehicle width direction, and a keyhole of the key cylinder 45 is exposed to the outside of the vehicle. Thereafter, a mechanical key (not illustrated) is inserted into the key cylinder 45 and rotationally operated. As a result, the lock mechanism 14 to which the operating force is transmitted via a transmission member (not illustrated) and the lock switching mechanism 16 illustrated in FIG. 1 is manually switched from the locked state to the unlocked state.

Subsequently, when the door latch device 10 is operated to open in an emergency state, the rear-side portion 25a of the handle 25 is pushed inward in the vehicle width direction. As a result, the handle 25 rotates in the direction A1 in FIG. 2, and the transmission lever 30 rotates in the direction B1 in FIG. 4. However, in an emergency state, the latch mechanism 11 cannot be electrically actuated to open. In addition, the rotation of the handle 25 by the operation of the rear-side portion 25a is restricted at the normal operation position indicated by the dash-dot line in FIG. 3 due to the contact of the transmission lever 30 with the restriction lever 50 in the same manner as the operation in a normal state.

Next, in an emergency state, the emergency button 54 exposed by the rotation of the handle 25 is pushed inward in the vehicle width direction. As a result, the emergency button 54 pivotally supported by the rotary shaft 55 rotates in a direction G1 in FIG. 4, and the restriction lever 50 pivotally supported by the rotary shaft 51 rotates in a direction F1 away from the transmission lever 30 in FIG. 4. As a result, the rotational restriction of the transmission lever 30 in the direction B1 by the restriction lever 50 is released.

By releasing the restriction of the transmission lever 30, the handle 25 can be rotated in the direction A1 to an emergency operation position illustrated by the two-dot chain line in FIG. 3. By this operation, the transmission lever 30 is further rotated in the direction B1 in FIG. 4 to press the open lever 40. As a result, the open lever 40 pivotally supported by the rotary shaft 41 rotates in a direction D1, which is a lower side in FIG. 4. As a result, the operating force of the handle 25 is transmitted to the latch mechanism 11 via the transmission lever 30, the open lever 40, a rod 43, the lock mechanism 14 illustrated in FIG. 1, and the latch switching mechanism 13, and the latch mechanism 11 is manually switched from the latched state to the unlatched state. As a result, the door 1 illustrated in FIG. 3 can be opened.

Here, in the door 1 to which the door latch device 10 and the door handle device 20 are attached, when an excessive load (impact) is applied to the outer panel 2 due to a side collision, the outer panel 2 may be deformed. Further, due to the deformation of the outer panel 2, the handle 25 and the transmission lever 30 may rotate with respect to the base 21, and the same force as that in the opening operation in an emergency state may be transmitted to the door latch device 10 via the open lever 40. In this case, the latch mechanism 11 illustrated in FIG. 1 is actuated to open and the door 1 can be opened. Therefore, in the door handle device 20 of the present embodiment, the rotation of the handle 25 is restricted by the restriction lever 50 upon the side collision so that the unintended opening of the door 1 can be suppressed.

Below, a configuration for restricting the rotation of the handle 25 in a normal state and upon a side collision by one restriction lever 50 will be specifically described. In the following description, the term “normal state” refers to a state in which the latch mechanism 11 can be electrically actuated to open and a state in which an inertial force equal to or greater than a set value due to a side collision of an impact capable of deforming the outer panel 2 is not applied.

### Restriction Structure of Handle by Restriction Lever

Referring to FIGS. 3 and 4, the base 21 is attached to the vehicle interior side with respect to the outer panel 2. The handle 25 is attached to the vehicle exterior side with respect to the base 21 and is exposed to the vehicle exterior side via a through-hole of the outer panel 2. The transmission lever 30, the restriction lever 50, and the emergency button 54 are all attached to the vehicle interior side with respect to the base 21 and covered by the cover 22.

Referring to FIGS. 2 and 3, the handle 25 is arranged on the vehicle exterior side of the base 21 and is attached to the base 21 via the rotary shaft 27 extending in the vehicle height direction. The rotary shaft 27 is arranged on the rear side of the center of the handle 25 in the vehicle length direction, more specifically, in a quarter of the entire length of the handle 25 from the rear end. Thus, the handle 25 includes a portion 25a on the rear side and a portion 25b on the front side with respect to the rotary shaft 27.

The handle 25 is rotatable in the directions A1 and A2 by the rotary shaft 27 between an initial position indicated by a solid line and an emergency operation position indicated by a two-dot chain line in FIG. 3 via a normal operation position indicated by a dash-dot line. When the handle 25 is at the initial position indicated by the solid line in FIG. 3, the opening actuation of the latch mechanism 11 illustrated in FIG. 1 is impossible. When the handle 25 is rotated to the normal operation position indicated by the dash-dot line in FIG. 3, the latch mechanism 11 illustrated in FIG. 1 can be electrically actuated to open. When the handle 25 is rotated to the emergency operation position indicated by the two-dot chain line in FIG. 3, the latch mechanism 11 illustrated in FIG. 1 can be manually actuated to open.

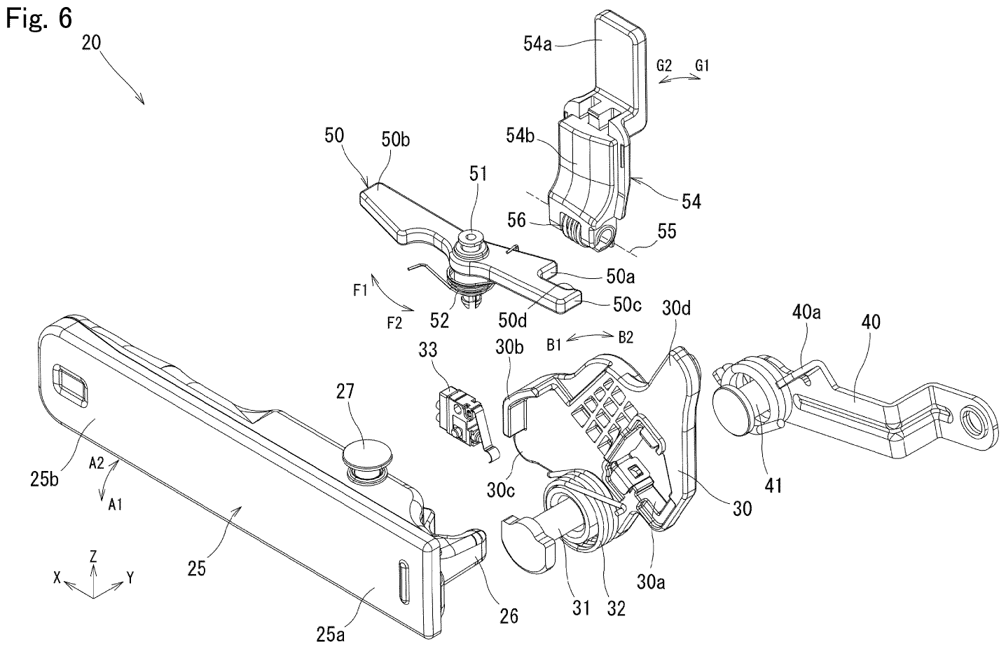

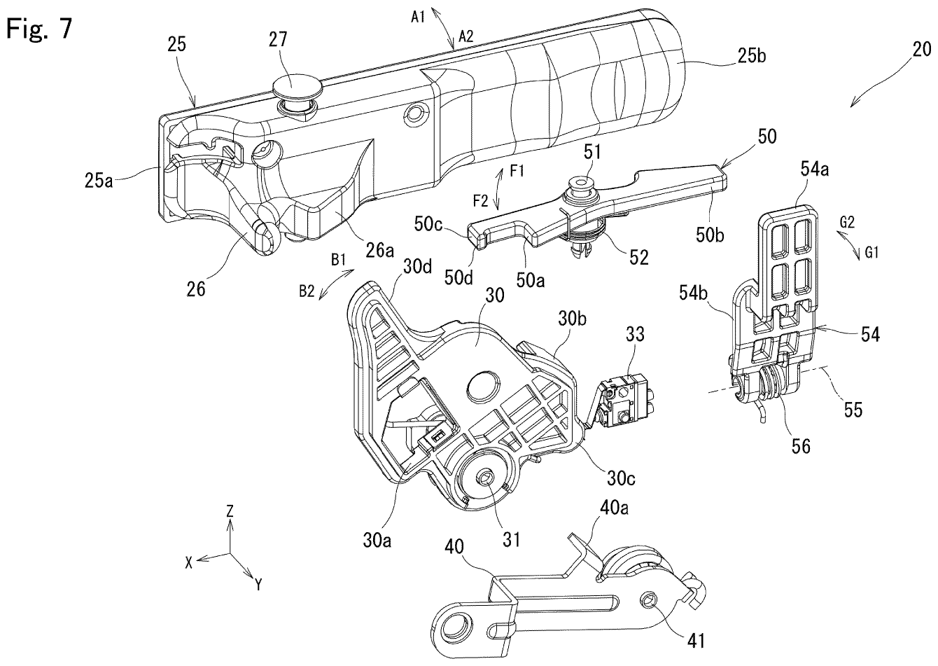

Referring to FIGS. 6 to 8, the handle 25 is provided with an operation portion 26 for rotating the transmission lever 30 and transmitting an operating force to the transmission lever 30. The operation portion 26 protrudes inward in the vehicle width direction from the rear-side portion 25a. A portion of the operation portion 26 on the front side in the vehicle length direction has a curved shape bulging forward. A reinforcing portion 26a for ensuring strength of the operation portion 26 is provided on the front side of the operation portion 26 in the vehicle length direction.

Referring to FIGS. 3 and 4, the transmission lever 30 has a flat plate shape, is arranged on the vehicle interior side opposite to the handle 25 with respect to the base 21, and is attached to the base 21 via the rotary shaft 31 extending in the vehicle width direction. By the rotary shaft 31, the transmission lever 30 rotates in the direction B1 in conjunction with the rotation of the handle 25 in the direction A1. In a normal state, the transmission lever 30 operates the release switch 33 to electrically actuate the lock mechanism 14 to unlock illustrated in FIG. 1 and electrically actuate the latch mechanism 11 to open. In an emergency state, the transmission lever 30 transmits the operating force of the handle 25 via the open lever 40 to manually actuate the latch mechanism 11 to open illustrated in FIG. 1.

An operation receiving portion 30a is provided on an upper side of the rotary shaft 31, which corresponds to the operation portion 26 of the handle 25 in the vehicle width direction, of the transmission lever 30. The operation receiving portion 30a is composed of a hole penetrating in the vehicle width direction, receives an operation by the operation portion 26, and rotates the transmission lever 30 in the direction B1 by the rotation of the handle 25 in the direction A1.

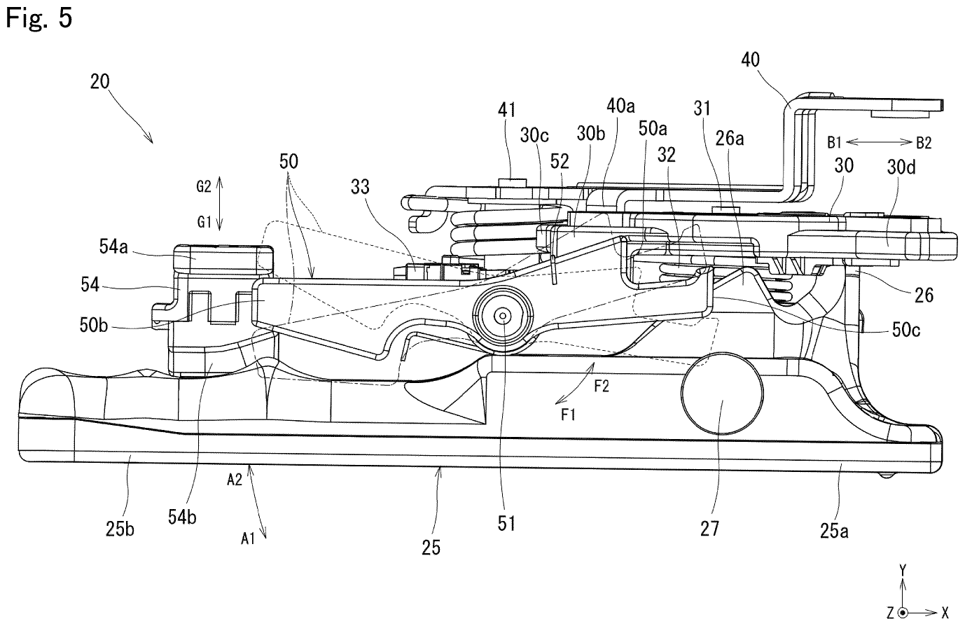

Referring to FIGS. 5 and 6, the transmission lever 30 is urged in the direction B2 by a spring 32. A torsion spring is used as the spring 32, one end of which is engaged with the transmission lever 30 and the other end of which is engaged with the base 21. By the biasing force of the spring 32, the handle 25 is urged in the direction A2 via the transmission lever 30. The rotation of the handle 25 in the direction A2 by the biasing force of the spring 32 is restricted due to contact with the end lever 35 urged in a direction C2 by a spring (not illustrated) (see FIG. 3). The handle 25 is positioned at the initial position indicated by the solid line in FIG. 3 by the biasing force of the spring 32 of the transmission lever 30 and the biasing force of the spring of the end lever 35.

Referring to FIGS. 5 to 7, the transmission lever 30 is further provided with a switch operation portion 30b, a lever operation portion 30c, and a restriction receiving portion 30d.

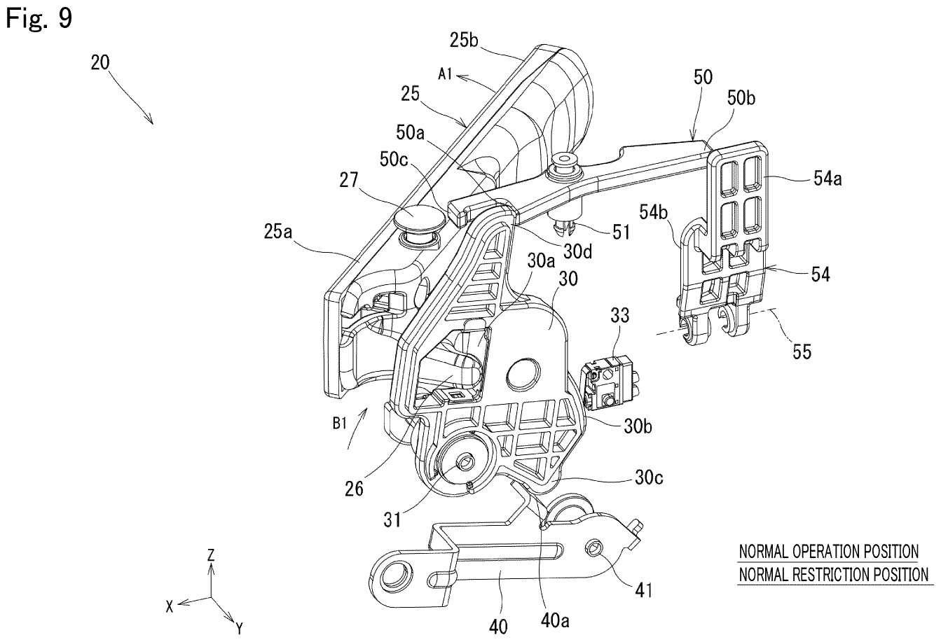

The switch operation portion 30b operates the release switch 33 arranged on the front side of the transmission lever 30 in the vehicle length direction by rotation in the direction B1 (see FIG. 9). The switch operation portion 30b is provided on the front side in the vehicle length direction with respect to the rotary shaft 31 so as to face the release switch 33 and protrudes so as to form a substantially triangular shape.

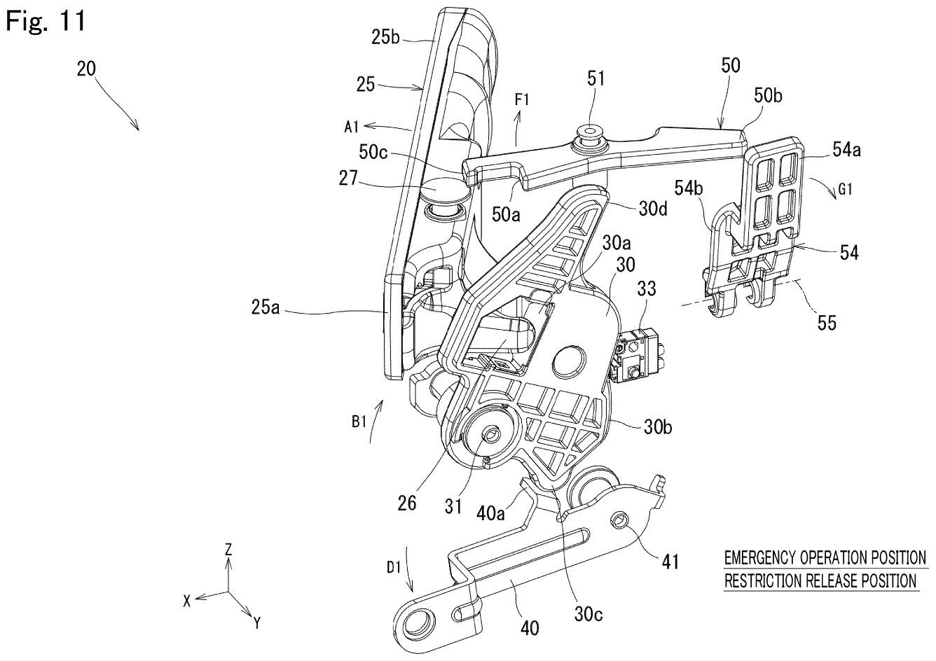

The lever operation portion 30c operates the operation receiving portion 40a of the open lever 40 arranged on a lower side of the transmission lever 30 by rotation in the direction B1 (see FIG. 11). The lever operation portion 30c is provided on the lower side of the switch operation portion 30b so as to face the open lever 40 and protrudes so as to form a substantially semicircular shape.

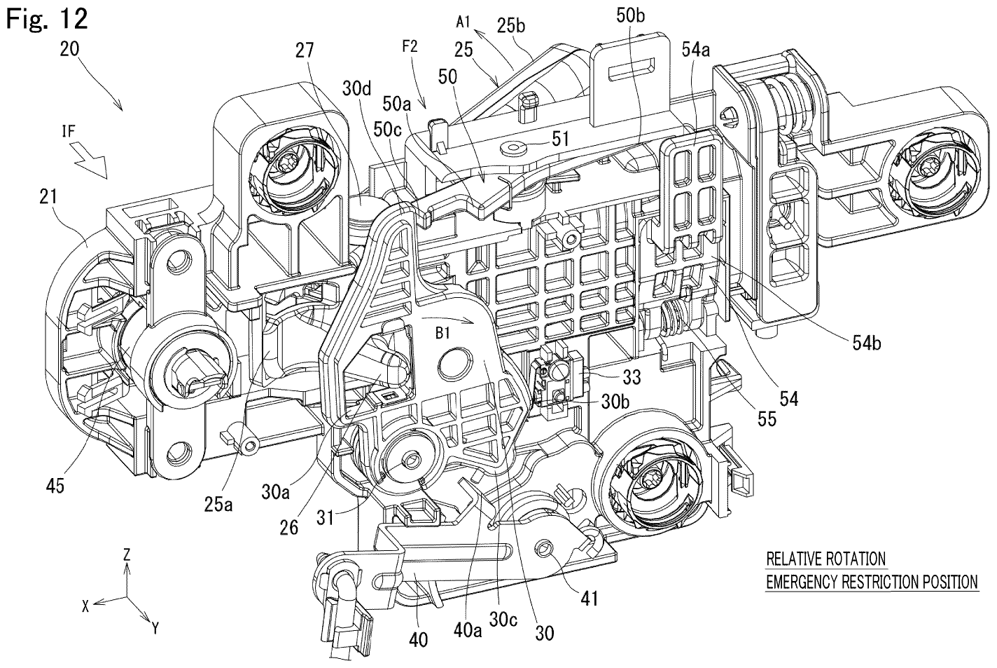

When the restriction receiving portion 30d rotates in the direction B1 in a normal state and/or upon a side collision, the restriction receiving portion comes into contact with the restriction lever 50 and restricts the operation of the open lever 40 by the lever operation portion 30c (see FIGS. 9 and 12). That is, the restriction receiving portion 30d is provided to come into contact with the restriction lever 50 before the lever operation portion 30c comes into contact with the open lever 40. The restriction receiving portion 30d is provided on an upper side of the operation receiving portion 30a and protrudes radially outward with respect to the rotary shaft 31.

Referring to FIG. 4, the restriction lever 50 has a flat plate shape elongated in the vehicle length direction, is arranged on the inner side in the vehicle width direction and the upper side with respect to the base 21, and is arranged adjacent to the front side of the transmission lever 30 in the vehicle length direction. The restriction lever 50 restricts rotation of the transmission lever 30 in the direction B1 in a normal state illustrated in FIG. 9 and/or during a side collision illustrated in FIG. 12. Thus, the restriction lever 50 restricts rotation of the handle 25 in the direction A1 via the transmission lever 30.

The restriction lever 50 is attached to the base 21 via a rotary shaft 51. The rotary shaft 51 passes through substantially a center in a length direction of the restriction lever 50. Referring to FIGS. 5 to 7, the restriction lever 50 is rotatable by the rotary shaft 51 in directions F1 and F2 to a normal restriction position indicated by a solid line in FIG. 5, a restriction release position indicated by a broken line in FIG. 5, and an emergency restriction position indicated by a dash-dot line in FIG. 5. When rotated to the normal restriction position indicated by the solid line, the restriction lever 50 extends in the vehicle length direction and restricts rotation of the handle 25 via the transmission lever 30. When rotated to the restriction release position indicated by the broken line, the end portion of the restriction lever 50 on the rear side in the vehicle length direction moves further outward in the vehicle width direction as compared with when rotated to the normal restriction position indicated by the solid line, thereby releasing the rotational restriction of the handle 25 via the transmission lever 30. When rotated to the emergency restriction position indicated by the dash-dot line, the end portion of the restriction lever 50 on the rear side in the vehicle length direction moves further inward in the vehicle width direction as compared with when rotated to the normal restriction position indicated by the solid line, thereby restricting the rotation of the handle 25 via the transmission lever 30. The emergency restriction position of the restriction lever 50 is rotated to a side opposite to the restriction release position with respect to the normal restriction position.

The restriction lever 50 is urged by a spring (biasing member) 52 in a direction F1 from the normal restriction position indicated by the solid line in FIG. 5 to the restriction release position indicated by the broken line in FIG. 5. A torsion spring is used as the spring 52, one end of which is engaged with the restriction lever 50 and the other end of which is engaged with the base 21. The rotation of the restriction lever 50 in the direction F1 by the spring 52 is restricted at the normal restriction position indicated by the solid line in FIG. 5 against the biasing force of the spring 52 due to contact with the emergency button 54.

The restriction lever 50 is provided with a normal restriction portion 50a, a contact portion (restriction release portion) 50b, and an emergency restriction portion 50c.

When the restriction lever 50 is at the normal restriction position indicated by the solid line in FIG. 5, the normal restriction portion 50a restricts rotation of the handle 25 from the normal operation position indicated by the dash-dot line in FIG. 3 to the emergency operation position indicated by the two-dot chain line in FIG. 3. The normal restriction portion 50a is provided on the rear side in the vehicle length direction with respect to the rotary shaft 51, is recessed from the inner side to the outer side in the vehicle width direction, and is configured by a cutout groove extending from the rear side to the front side in the vehicle length direction.

When the restriction lever 50 is rotated to the normal restriction position indicated by the solid line in FIG. 5, the normal restriction portion 50a is positioned on the front side of the transmission lever 30 in the vehicle length direction and is positioned on a rotation trajectory of the restriction receiving portion 30d in the direction B1. When the restriction lever 50 is rotated to the restriction release position indicated by the broken line in FIG. 5, the normal restriction portion 50a is separated outward in the vehicle width direction from the transmission lever 30 and is positioned on the rotation trajectory of the restriction receiving portion 30d in the direction B1. When the restriction lever 50 is rotated to the emergency restriction position indicated by the dash-dot line in FIG. 5, the normal restriction portion 50a is positioned further inward in the vehicle width direction with respect to the normal restriction position indicated by the solid line in FIG. 5.

The contact portion 50b is a restriction release portion for positioning the restriction lever 50 to the normal restriction position indicated by the solid line in FIG. 5 in a normal state and rotating the restriction lever 50 to the restriction release position indicated by the broken line in FIG. 5 in an emergency state. The contact portion 50b is configured by a front-side end portion of a portion of the restriction lever 50 positioned on the front side in the vehicle length direction with respect to the rotary shaft 51.

In a normal state, the contact portion 50b is brought into contact with the emergency button 54 due to the biasing of the restriction lever 50 by the spring 52, and positions the restriction lever 50 to the normal restriction position indicated by the solid line in FIG. 5. In an emergency state in which the emergency button 54 is operated, the contact portion 50b moves following movement of the emergency button 54 due to the biasing of the restriction lever 50 by the spring 52. As a result, the contact portion 50b is positioned further inward in the vehicle width direction with respect to the normal restriction position indicated by the solid line in FIG. 5, and releases the rotational restriction of the transmission lever 30 by the normal restriction portion 50a. Upon a side collision in which an inertial force equal to or greater than a set value is applied to the outer panel 2 illustrated in FIG. 3, the contact portion 50b is movable further outward in the vehicle width direction with respect to the normal restriction position indicated by the solid line in FIG. 5 against the biasing force of the spring 52.

The emergency restriction portion 50c is configured by a rear-side end portion of a portion of the restriction lever 50 positioned on the rear side in the vehicle length direction with respect to the rotary shaft 51. When the restriction lever 50 is rotated to the emergency restriction position indicated by the dash-dot line in FIG. 5, the emergency restriction portion 50c is positioned on the front side of the transmission lever 30 in the vehicle length direction and is positioned on the rotation trajectory of the restriction receiving portion 30d in the direction B1. This restricts the rotation of the transmission lever 30 in the direction B1, thereby restricting the rotation of the handle 25 to the emergency operation position indicated by the two-dot chain line in FIG. 3.

The emergency restriction portion 50c includes a protrusion 50d protruding inward in the vehicle width direction. A region where the restriction receiving portion 30d of the transmission lever 30 can be brought into contact is secured by the emergency restriction portion 50c including the protrusion 50d. A protruding amount of the protrusion 50d from a groove wall of the cutout groove constituting the normal restriction portion 50a is as large as possible within a range that does not hinder the entry of the restriction receiving portion 30d of the transmission lever 30 into the normal restriction portion 50a. For example, a dimension in the vehicle width direction of the emergency restriction portion 50c including the protrusion 50d is approximately twice a thickness of the restriction receiving portion 30d of the transmission lever 30.

The restriction lever 50 having the above-described configuration is configured by a mass body that is relatively movable with respect to the base 21 by the action of an inertial force equal to or greater than a set value. Here, the mass body means a member that is made of a material having a specific gravity larger than that of a resin and can continue to stay at a current position by its own weight when an impact IF (see FIG. 12) is applied to the outer panel 2 illustrated in FIG. 3 including the door handle device 20 and an inertial force acts thereon.

More specifically, when the outer panel 2 is deformed by an impact, the base 21 moves integrally with the deformation. At this time, due to the action of the inertial force equal to or greater than the set value, the restriction lever 50 formed of the mass body remains so as to maintain a posture before the action of the inertial force with respect to the moving base 21. Thus, the restriction lever 50 rotates against the biasing force of the spring 52 from the normal restriction position indicated by the solid line in FIG. 5 to the emergency restriction position indicated by the dash-dot line in FIG. 5. As a result, the emergency restriction portion 50c of the restriction lever 50 is positioned on the rotation trajectory of the restriction receiving portion 30d of the transmission lever 30, and the rotation of the transmission lever 30 in the direction B1 is restricted.

The emergency button 54 is an operation member for moving the restriction lever 50 from the normal restriction position indicated by the solid line in FIG. 5 to the restriction release position indicated by the broken line in FIG. 5. Referring to FIGS. 3 and 4, the emergency button 54 is arranged on the inner side of the base 21 in the vehicle width direction and adjacent to the lower side of the contact portion 50b of the restriction lever 50, and is attached to a rotary shaft 55 formed on the base 21.

Referring to FIGS. 5 to 7, the emergency button 54 is rotatable in directions G1 and G2 of the vehicle width direction by the rotary shaft 55. More specifically, a lower end of the emergency button 54 is pivotally supported by the rotary shaft 55, and a portion of the emergency button 54 above the rotary shaft 55 is swingable in the vehicle width direction.

The emergency button 54 is urged by a spring 56 in the direction G2 toward the contact portion 50b of the restriction lever 50 positioned on the outer side in the vehicle width direction. A torsion spring is used as the spring 56, one end of which is engaged with the emergency button 54 and the other end of which is engaged with the base 21. The rotation of the emergency button 54 in the direction G2 by the biasing force of the spring 56 is restricted by the contact with the base 21.

The emergency button 54 is provided with an operation portion 54b and a support portion 54a.

The support portion 54a comes into contact with the contact portion 50b of the restriction lever 50 and supports the restriction lever 50 at the normal restriction position indicated by the solid line in FIG. 5 by the biasing force of the spring 56. That is, the biasing force of the spring 56 in the direction G2 of the emergency button 54 is greater than the biasing force of the spring 52 in the direction F1 of the restriction lever 50. The support portion 54a has a plate shape and protrudes upward from the operation portion 54b. When the support portion 54a comes into contact with the base 21, the rotation of the emergency button 54 in the direction G2 is restricted.

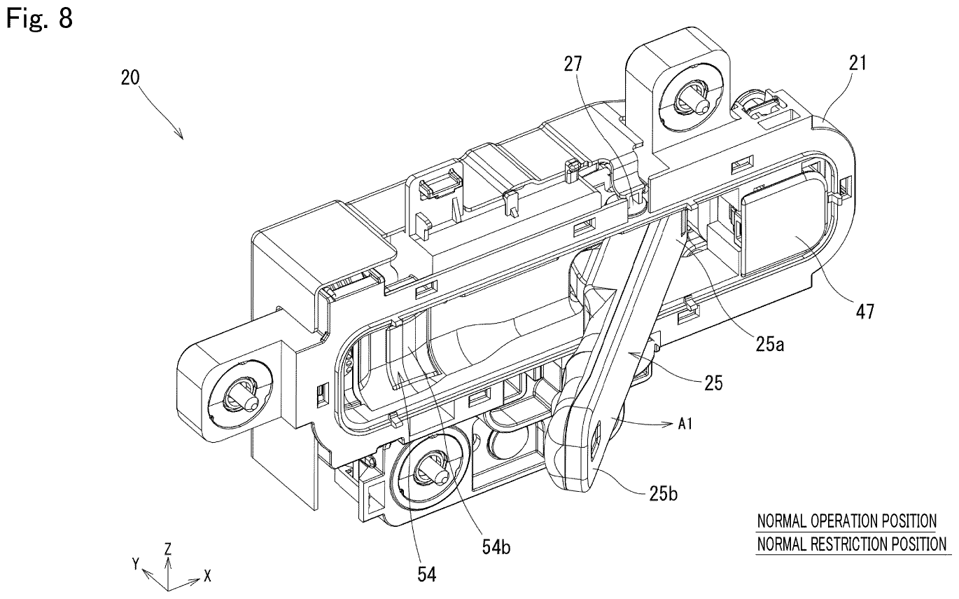

The operation portion 54b is configured to operate the contact portion 50b via the support portion 54a to release the rotational restriction of the transmission lever 30 (the handle 25) by the restriction lever 50. The operation portion 54b can be exposed to the outside of the vehicle through a through-hole formed in the base 21. More specifically, as illustrated in FIGS. 2 and 3, in a state where the handle 25 is rotated to the initial position, the operation portion 54b is covered and hidden by the handle 25. As illustrated in FIGS. 3 and 8, in a state where the handle 25 is rotated to the normal operation position, the operation portion 54b is exposed to the outside of the vehicle and can be operated from the outer side in the vehicle-width direction toward the direction G1.

In the door handle device 20 configured as described above, when the door latch device 10 illustrated in FIG. 1 is operated to open in a normal state, the rear-side portion 25a of the handle 25 at the initial position is pushed inward in the vehicle width direction as described above. Thus, as illustrated in FIGS. 8 and 9, the handle 25 rotates in the direction A1, and the transmission lever 30 rotates in the direction B1 by the operation portion 26. When the restriction receiving portion 30d of the transmission lever 30 comes into contact with the normal restriction portion 50a of the restriction lever 50, the rotation of the transmission lever 30 in the direction B1 and the rotation of the handle 25 in the direction A1 are restricted. As a result, the transmission lever 30 can electrically actuate the lock mechanism 14 and the latch mechanism 11 illustrated in FIG. 1 by the operation of the release switch 33. However, since the transmission lever 30 cannot operate the open lever 40, the operating force of the handle 25 cannot be transmitted to the door latch device 10 illustrated in FIG. 1.

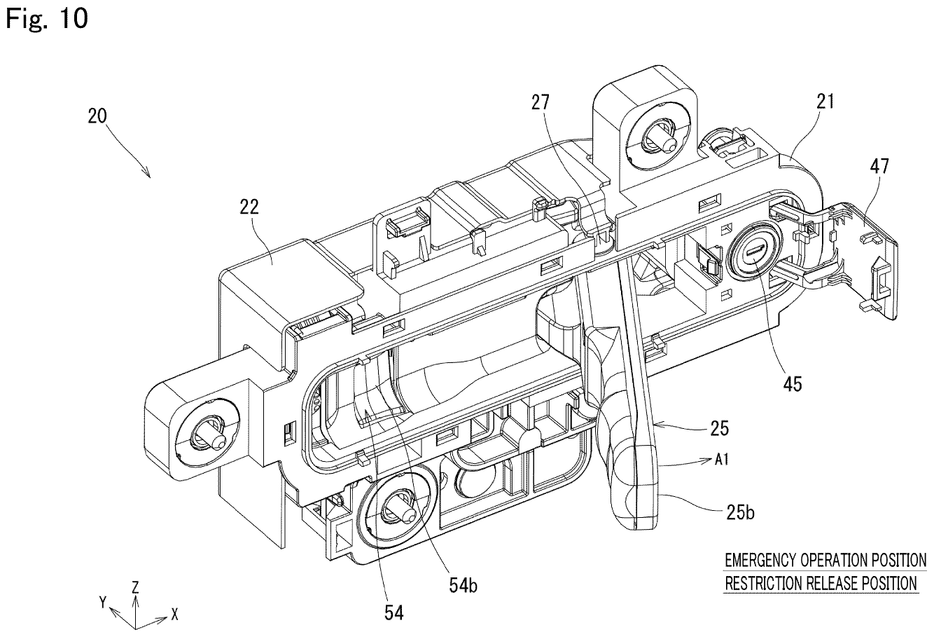

On the other hand, when operating the door latch device 10 illustrated in FIG. 1 to open in an emergency, first, the rear-side portion 25a of the handle 25 at the initial position is operated to bring the door latch device 10 into the restricted state illustrated in FIGS. 8 and 9. In this state, the exposed operation portion 54b of the emergency button 54 is pushed inward from the outer side in the vehicle width direction. Thus, as illustrated in FIGS. 10 and 11, the support portion 54a of the emergency button 54 moves in the direction G1, and the restriction lever 50 follows the movement and rotates in the direction F1 by the biasing force of the spring 52. As a result, the rotational restriction of the transmission lever 30 by the normal restriction portion 50a of the restriction lever 50 is released.

By releasing the restriction of the transmission lever 30 by the restriction lever 50, the handle 25 can be further operated in the direction A1 by gripping the front-side portion 25b. By this operation, the transmission lever 30 is further rotated in the direction B1 with respect to the restricted state illustrated in FIG. 9, so that the open lever 40 is operated. As a result, the open lever 40 rotates in the direction D1, so the latch mechanism 11 mechanically connected via the rod 43 (see FIG. 4), the lock mechanism 14 illustrated in FIG. 1, and the latch switching mechanism 13 can be manually actuated to open.

Upon a side collision, that is, when an impact is applied to the door 1 illustrated in FIG. 3 from the outside of the vehicle, the outer panel 2 is deformed, and an inertial force equal to or greater than a set value is applied, the door handle device 20 is brought into a state illustrated in FIG. 12. Specifically, although the base 21 also moves due to the deformation of the outer panel 2, the restriction lever 50 formed of the mass body tends to remain at the posture before the action of the inertial force. Therefore, the restriction lever 50 is relatively rotated to the emergency restriction position with respect to the base 21.

When the restriction lever 50 is rotated to the emergency restriction position, the emergency restriction portion 50c is positioned on the rotation trajectory of the restriction receiving portion 30d of the transmission lever 30. Therefore, even if a rotating force acts on the transmission lever 30, the restriction receiving portion 30d comes into contact with the emergency restriction portion 50c of the restriction lever 50, so that the rotation of the transmission lever 30 in the direction B1 and the rotation of the handle 25 in the direction A1 are restricted. Thus, since the transmission lever 30 cannot operate the open lever 40, the operating force of the handle 25 cannot be transmitted to the door latch device 10 illustrated in FIG. 1. As a result, since the latch mechanism 11 cannot be actuated to open, the unintended opening of the door 1 can be suppressed.

The door handle device 20 configured as described above has the following features.

The restriction lever 50 is movable between the normal restriction position and the restriction release position in a normal state in which the inertial force equal to or greater than the set value is not applied, and is movable to the emergency restriction position when the inertial force equal to or greater than the set value is applied. In addition, the restriction lever 50 includes the normal restriction portion 50a that restricts rotation of the handle 25 when the restriction lever is at the normal restriction position and the emergency restriction portion 50c that restricts rotation of the handle 25 when the restriction lever is at the emergency restriction position. Thus, the rotational restriction of the handle 25 in the normal state in which the inertial force equal to or greater than the set value is not applied and the rotational restriction of the handle 25 upon the side collision during which the inertial force equal to or greater than the set value is applied can be performed by one restriction lever 50. Thus, it is not necessary to separately provide a restriction lever for the normal state and a restriction lever for a side collision. Therefore, it is possible to restrict the handle operation in the normal state and to suppress the unintended opening of the door upon a side collision, without an excessive increase in the number of parts.

The restriction lever 50 restricts the rotation of the transmission lever 30 that transmits the operating force of the handle 25 to the latch mechanism 11, thereby restricting the rotation of the handle 25 via the transmission lever 30. Therefore, the rotation of the handle 25 arranged on the vehicle exterior side of the base 21 can be reliably restricted on the vehicle interior side of the base 21. Therefore, since it is not necessary to provide the handle 25 with a structure for restricting the rotation, the degree of freedom in design of the handle 25 can be improved.

The emergency button 54 for releasing the restriction by the restriction lever 50 has the support portion 54a for supporting the contact portion 50b and the operation portion 54b for operating the contact portion 50b via the support portion 54a. Therefore, the rotational restriction of the handle 25 by the restriction lever 50 can be easily released simply by operating the operation portion 54b. Therefore, without an excessive increase in the number of parts, the rotation of the handle 25 to the emergency operation position can be prevented in the normal state in which the latch mechanism 11 can be electrically actuated to open, and the handle 25 can be reliably operated to the emergency operation position in the emergency state in which the latch mechanism 11 cannot be electrically actuated to open.

The door handle device 20 includes the spring 52 for biasing the restriction lever 50 from the normal restriction position toward the restriction release position, and the restriction lever 50 is positioned at the normal restriction position against the biasing force of the spring 52 by the contact of the contact portion 50b with the support portion 54a. Therefore, when the support of the restriction lever 50 by the support portion 54a is released by the operation of the emergency button 54, the restriction lever 50 can be reliably moved to the restriction release position by the biasing force of the spring 52. Therefore, the rotational restriction of the handle 25 by the restriction lever 50 can be reliably released.

The emergency restriction position of the restriction lever 50 is positioned on the opposite side to the restriction release position with respect to the normal restriction position, and the restriction lever 50 is configured by a mass body relatively movable to the emergency restriction position by the action of an inertial force equal to or greater than a set value. Therefore, the rotation of the handle 25 upon a side collision can be reliably restricted by the restriction lever 50, and the unintended opening of the door 1 can be suppressed.

Note that the present invention is not limited to the configuration of the above-described embodiment, and various modifications can be made.

For example, the directions A1 and A2 in which the handle 25 rotates and the directions B1 and B2 in which the transmission lever 30 rotates can be changed as necessary as long as the transmission lever 30 is configured to rotate in conjunction with the rotation of the handle 25. The directions F1 and F2 in which the restriction lever 50 rotates can be changed as necessary as long as the rotation of the transmission lever 30 in the direction B1 can be restricted in the normal state and upon the side collision and the rotational restriction of the transmission lever 30 can be released in the emergency state. The directions G1 and G2 in which the emergency button 54 rotates can be changed as necessary as long as the rotation of the restriction lever 50 in the direction F1 can be restricted in the normal state and the rotation of the restriction lever 50 in the direction F1 can be permitted in the emergency state.

The restriction lever 50 may be configured to directly restrict the rotation of the handle 25 in the direction A1. Further, the restriction lever 50 may be configured such that the contact portion (restriction release portion) 50b is exposed from the base 21 to the vehicle exterior side and is directly operated. In addition, the restriction lever 50 may be configured by a member other than the mass body as long as the restriction lever 50 can be moved to the emergency restriction position by the action of the inertial force equal to or greater than the set value.

What is claimed is:

1. A door handle device comprising:
a base to be attached to a door;
a handle attached to a vehicle exterior side of the base and configured to be rotatable between an initial position in which a door latch device attached to the door is not to be actuated to open and an emergency operation position in which the door latch device is manually actuated to open, via a normal operation position for electrically actuating the door latch device to open; and
a restriction lever attached to the base, wherein
the restriction lever is movable to a normal restriction position in which rotation of the handle is restricted, a restriction release position in which rotational restriction of the handle is released, and an emergency restriction position in which rotation of the handle is restricted when an inertial force equal to or greater than a set value is applied, and
includes:
a normal restriction portion that restricts rotation of the handle from the normal operation position to the emergency operation position when the restriction lever is positioned at the normal restriction position,
a restriction release portion for releasing rotational restriction of the handle by the normal restriction portion; and
an emergency restriction portion that restricts rotation of the handle to the emergency operation position when the restriction lever is positioned at the emergency restriction position.

2. The door handle device according to claim 1, further comprising a transmission lever attached to a vehicle interior side of the base and configured to rotate in conjunction with rotation of the handle and to transmit an operating force of the handle to the door latch device to actuate the door latch device to open, wherein
the restriction lever restricts rotation of the handle via the transmission lever by restricting rotation of the transmission lever.

3. The door handle device according to claim 1, further comprising an operation member attached to the base and configured to move the restriction lever from the normal restriction position to the restriction release position, wherein
the operation member includes a support portion that supports the restriction release portion, and an operation portion that operates the restriction release portion via the support portion and releases rotational restriction of the handle by the restriction lever.

4. The door handle device according to claim 3, further comprising a biasing member configured to bias the restriction lever from the normal restriction position toward the restriction release position, wherein
the restriction lever is positioned at the normal restriction position against a biasing force of the biasing member by contact of the restriction release portion with the support portion.

5. The door handle device according to claim 4, wherein
the emergency restriction position of the restriction lever is positioned on a side opposite to the restriction release position with respect to the normal restriction position, and
the restriction lever is configured by a mass body that is relatively movable from the normal restriction position to the emergency restriction position against the biasing force of the biasing member by an action of an inertial force equal to or greater than the set value.

6. The door handle device according to claim 2, further comprising an operation member attached to the base and configured to move the restriction lever from the normal restriction position to the restriction release position, wherein
the operation member includes a support portion that supports the restriction release portion, and an operation portion that operates the restriction release portion via the support portion and releases rotational restriction of the handle by the restriction lever.

7. The door handle device according to claim 6, further comprising a biasing member configured to bias the restriction lever from the normal restriction position toward the restriction release position, wherein
the restriction lever is positioned at the normal restriction position against a biasing force of the biasing member by contact of the restriction release portion with the support portion.

8. The door handle device according to claim 7, wherein
the emergency restriction position of the restriction lever is positioned on a side opposite to the restriction release position with respect to the normal restriction position, and
the restriction lever is configured by a mass body that is relatively movable from the normal restriction position to the emergency restriction position against the biasing force of the biasing member by an action of an inertial force equal to or greater than the set value.
